(19) United States
(12) Patent Application Publication
(10) Pub. No.: US 2024/0354715 A1
(43) Pub. Date: Oct. 24, 2024

(54) PREDICTIVE MAINTENANCE ALGORITHM PROVIDING METHOD FOR BUS MAINTENANCE PRIORITY DETERMINATION

(71) Applicants: THE IMC, Daegu (KR); KOREA TRANSPORTATION SAFETY AUTHORITY, Gyeongsangbuk-do (KR)

(72) Inventors: Hyung Jin SON, Daegu (KR); Sang Woo SON, Daegu (KR); Yoon Hyun KIM, Daegu (KR); Tae Hwan LEE, Daegu (KR); Hyuck Joon BYUN, Daegu (KR); Jae Hwan JEONG, Gyeongsangbuk-do (KR); Ji Yang PARK, Gyeongsangbuk-do (KR)

(21) Appl. No.: 18/640,327

(22) Filed: Apr. 19, 2024

(30) Foreign Application Priority Data
Apr. 20, 2023 (KR) 10-2023-0052101

(51) Int. Cl. G06Q 10/20; G07C 5/00

(52) U.S. Cl. CPC G06Q 10/20; G07C 5/006

(57) ABSTRACT

A predictive maintenance algorithm providing method for bus maintenance priority determination according to the present invention includes operations of (a) grouping and classifying, by a data processing unit of an operational server, a plurality of buses to be monitored according to preset classification criteria, (b) receiving, by a monitoring unit of the operational server, bus monitoring information including a plurality of types of data collected by vehicle information collection devices installed on the buses for each group classified according to the operation (a), (c) performing, by the data processing unit, refinement on the bus monitoring information, (d) inputting, by the data processing unit, the bus monitoring information refined in the operation (c) as training data for an artificial intelligence machine to build an artificial intelligence model for determining bus maintenance priorities, (e) re-receiving, by the monitoring unit, the bus monitoring information collected by the vehicle information collection devices installed on the buses for each group classified according to the operation (a), and (f) deriving, by a data analysis unit of the operational server, the maintenance priority of the bus to be monitored through the artificial intelligence model based on the bus monitoring information re-received in the operation (e).

### CROSS-REFERENCE TO RELATED APPLICATIONS

This application claims priority to Korean Patent Application No. 10-2023-0052101, filed on Apr. 20, 2023, the disclosure of which is incorporated by reference herein in its entirety.

### BACKGROUND

### 1. Technical Field

The present invention relates to an algorithm for predictive maintenance of buses, and more particularly, to a method of providing a predictive maintenance algorithm through a bus maintenance priority determination process.

### 2. Related Art

Unlike in the past in which buses were simply dispatched and operated by time, in recent years, a bus operation management system (bus information system) has been introduced and operated to efficiently manage city bus operations.

This bus information system provides functions of collecting bus operation information, monitoring bus operation situations, providing real-time bus arrival information to passengers, and providing optimizing operation plans.

Specifically, the bus information system is composed of various subsystems, including a global positioning system (GPS), an integrated operation management system, a real-time arrival information system, an operation monitoring system, and a passenger information collection system.

The GPS tracks the position of a bus in real time through a GPS device mounted on the bus and collects information such as the route, speed, and estimated arrival time of a bus.

The integrated operation management system is a system that collects bus operation information and manages the collected bus operation information in an integrated manner, and manages operation schedules, routes, driver information, bus maintenance records, etc., and optimizes bus operation plans.

The real-time arrival information system is a system that provides bus arrival information to passengers in real time and allows passengers to know a bus arrival time in advance, minimize waiting time, and use the bus conveniently.

The operation monitoring system monitors bus operation situations, detects abnormal situations such as accidents or stops that occur during bus operation, and allows quick responses.

The passenger information collection system analyzes passenger usage patterns and usage status to optimize operation schedules and routes and establish efficient operation plans.

Meanwhile, in addition to the above-described bus information system, in recent years, various institutional devices for preventing accidents caused by driver negligence, such as a digital tachograph and a lane departure warning device, have been introduced, so city bus traffic accidents are gradually decreasing, but accident prevention activities from a vehicle perspective are still in an underdeveloped state.

To explain in more detail, although the accident prevention activities from the vehicle perspective are currently in progress through regular inspections of city buses, this method has the limitation of not being able to check the status of defects that occur during an inspection period or parts excluded from inspection items.

In addition, there is a problem that batteries and electric motors, which have a significant effect on accident situations of eco-friendly vehicles that have recently become widely available, are not currently subject to regular inspection.

Therefore, a method for solving these problems is required.

### RELATED ART DOCUMENT

### Patent Document

Korean Patent No. 10-1349935

### DISCLOSURE

### Technical Problem

The present invention is to perform analysis from a vehicle perspective through an artificial intelligence model using bus data uploaded in real time so as to be able to monitor the state of a bus and prevent accidents and breakdowns through the analysis.

The problems of the present invention are not limited to the above-described problems. That is, other problems that are not described may be clearly understood by those skilled in the art from the following description.

### Technical Solution

According to an embodiment of the present invention, a predictive maintenance algorithm providing method for bus maintenance priority determination according to the present invention includes operations of (a) grouping and classifying, by a data processing unit of an operational server, a plurality of buses to be monitored according to preset classification criteria, (b) receiving, by a monitoring unit of the operational server, bus monitoring information including a plurality of types of data collected by vehicle information collection devices installed on the buses for each group classified according to the operation (a), (c) performing, by the data processing unit, refinement on the bus monitoring information, (d) inputting, by the data processing unit, the bus monitoring information refined in the operation (c) as training data for an artificial intelligence machine to build an artificial intelligence model for determining bus maintenance priorities, (e) re-receiving, by the monitoring unit, the bus monitoring information collected by the vehicle information collection devices installed on the buses for each group classified according to the operation (a), and (f) deriving, by a data analysis unit of the operational server, the maintenance priority of the bus to be monitored through the artificial intelligence model based on the bus monitoring information re-received in the operation (e).

The preset classification criterion in the operation (a) may have at least one criterion among a manufacturer, fuel, a model, year, and a system type.

The operation (c) may include (c-1) filtering, by the data processing unit, a data error in the bus monitoring information, (c-2) performing, by the data processing unit, preprocessing on data of the bus monitoring information, and (c-3) backing up and loading, by the data processing unit, the data of the bus monitoring information into a database of the operational server.

The operation (f) may include (f-1) generating, by the data analysis unit, a state prediction model of the bus to be monitored through the artificial intelligence model, (f-2) generating, by the data analysis unit, a steady state model of the bus to be monitored through the artificial intelligence model, (f-3) calculating, by the data analysis unit, a Euclidean distance between the state prediction model and the steady state model, and (f-4) deriving, by the data analysis unit, maintenance priorities in the decreasing order of the Euclidean distance calculated in the operation (f-3).

The predictive maintenance algorithm providing method may further include, between the operations (c) and (d), operation (ex1) of setting, by the data processing unit of the operational server, a threshold standard for determining normal/abnormal data based on the bus monitoring information refined in the operation (c).

The operation (ex1) may include one or more operations selected from the group consisting of: (ex1-1) receiving, by the data processing unit, an expert threshold value calculated by an automobile-related expert and setting the received expert threshold value as a first threshold standard, (ex1-2) deriving, by the data processing unit, a numerical threshold value calculated through a statistical technique and setting the derived numerical threshold value as a second threshold standard, and (ex1-3) deriving, by the data processing unit, a displacement difference threshold value calculated through an offset method and setting the derived displacement difference threshold value as a third threshold standard.

The predictive maintenance algorithm providing method may further include, after the operation (ex1), operation (ex2) of processing, by the data processing unit, the bus monitoring information to build the training data to be input to the artificial intelligence machine in the operation (d).

The operation (ex2) may include operations of (ex2-1) standardizing, by the data processing unit, the bus monitoring information, (ex2-2) performing, by the data processing unit, preprocessing on the bus monitoring information standardized in the operation (ex2-1), (ex2-3) setting, by the data processing unit, an analysis unit for the bus monitoring information preprocessed in the operation (ex2-2), and (ex2-4) classifying, by the data processing unit, each piece of data of the bus monitoring information as normal data or abnormal data according to the threshold standard set in the operation (ex1).

### Advantageous Effects

In order to solve the above problems, a predictive maintenance algorithm providing method for bus maintenance priority determination of the present invention can group a plurality of buses to be monitored according to preset classification criteria and collect bus monitoring information in real time and use the collected bus monitoring information as training data to derive an artificial intelligence model for determining bus maintenance priorities, thereby deriving bus maintenance priority based on reasonable and objective standards.

In particular, the present invention can be applied to electric buses and hydrogen electric buses that are not currently subject to regular inspection, thereby preventing accidents and breakdowns even in eco-friendly vehicles.

The effects of the present invention are not limited to the above-described effects. That is, other effects that are not described may be obviously understood by those skilled in the art from the claims.

### BRIEF DESCRIPTION OF DRAWINGS

FIG. 1 is a diagram illustrating the entire process of a predictive maintenance algorithm providing method for bus maintenance priority determination according to an embodiment of the present invention.

FIG. 2 is a diagram schematically illustrating each component in a system for performing the predictive maintenance algorithm providing method for bus maintenance priority determination according to the embodiment of the present invention.

FIG. 3 is a diagram illustrating the detailed process of operation (c) in the predictive maintenance algorithm providing method for bus maintenance priority determination according to the embodiment of the present invention.

FIG. 4 is a diagram illustrating the detailed process of operation (f) in the predictive maintenance algorithm providing method for bus maintenance priority determination according to the embodiment of the present invention.

FIG. 5 is a diagram illustrating operations (ex1) and (ex2) performed between operations (c) and (d) in the predictive maintenance algorithm providing method for bus maintenance priority determination according to the embodiment of the present invention.

FIG. 6 is a diagram illustrating the detailed process of operation (ex1) in the predictive maintenance algorithm providing method for bus maintenance priority determination according to the embodiment of the present invention.

FIG. 7 is a diagram illustrating the detailed process of operation (ex2) in the predictive maintenance algorithm providing method for bus maintenance priority determination according to the embodiment of the present invention.

### DESCRIPTION OF EXAMPLE EMBODIMENTS

In this specification, when a first component (or region, layer, portion, etc.) is referred to as being “on,” “connected to,” or “coupled to” a second component, it means that the first component may be arranged/connected/coupled directly on the second component or a third component may be arranged therebetween.

Like reference numerals refer to like elements. In addition, in the accompanying drawings, the thicknesses, proportions, and dimensions of components are exaggerated for efficient description of technical contents.

The term “and/or” includes any and all combinations of one or more of the associated listed items.

Terms used in the specification such as “first,” “second,” etc., may be used to describe various components, but the components are not to be interpreted as being limited by the terms. The terms are used only to distinguish one component from another component. For example, a first component may be named a second component, and similarly, the second component may also be named the first component, without departing from the scope of the present invention. Singular forms are intended to include plural forms unless the context clearly indicates otherwise.

In addition, terms such as “below,” “on the lower side,” “above,” and “on the upper side” are used to describe the relationship between components illustrated in the drawings. The above terms are relative concepts and are described based on a direction indicated in the drawings.

Unless defined otherwise, all terms (including technical and scientific terms) used herein have the same meaning as generally understood by one of ordinary skill in the art to which the present invention belongs. In addition, terms such as those defined in commonly used dictionaries should be construed as having meanings consistent with their meanings in the context of the relevant technology, and unless interpreted in an idealized or overly formal meaning, are explicitly defined herein.

It should be further understood that terms “include” and “have” specify the presence of features, numbers, steps, operations, components, parts mentioned in the present specification, or combinations thereof, but do not preclude the presence or addition of one or more other features, numbers, steps, operations, components, parts, or combinations thereof.

Hereinafter, embodiments of the present invention will be described in detail with reference to the accompanying drawings.

A predictive maintenance algorithm providing method for bus maintenance priority determination based on real-time location information according to the present invention is performed through an operational server on which a program for providing a predictive maintenance algorithm for determining bus maintenance priority based on real-time location information stored in a storage medium is installed and may be driven by a processor of the operational server.

In addition, the program for providing a predictive maintenance algorithm for determining bus maintenance priority based on real-time location information may be output through a video output device such as a display module, and visible information may be provided through a graphical user interface visualized on an operational server or the like.

In particular, the program for providing a predictive maintenance algorithm for determining bus maintenance priority based on real-time location information may be installed on the operational server or the like using a removable disk or a communication network, and a predictive maintenance algorithm providing method for bus maintenance priority determination based on real-time location information may be operated through various functional means.

That is, in the present invention, information processing by software is concretely realized through hardware.

Hereinafter, the predictive maintenance algorithm providing method for bus maintenance priority determination based on real-time location information according to embodiments of the present invention will be described with reference to the accompanying drawings.

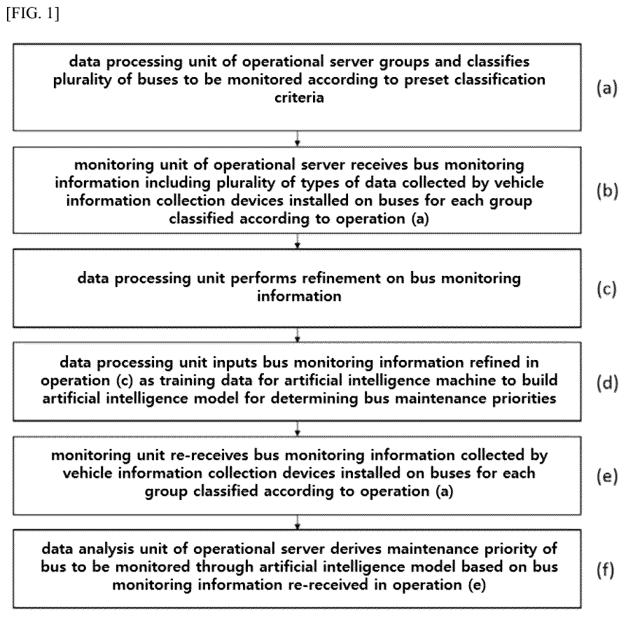

FIG. 1 is a diagram illustrating the entire process of a predictive maintenance algorithm providing method for bus maintenance priority determination based on real-time location information according to an embodiment of the present invention.

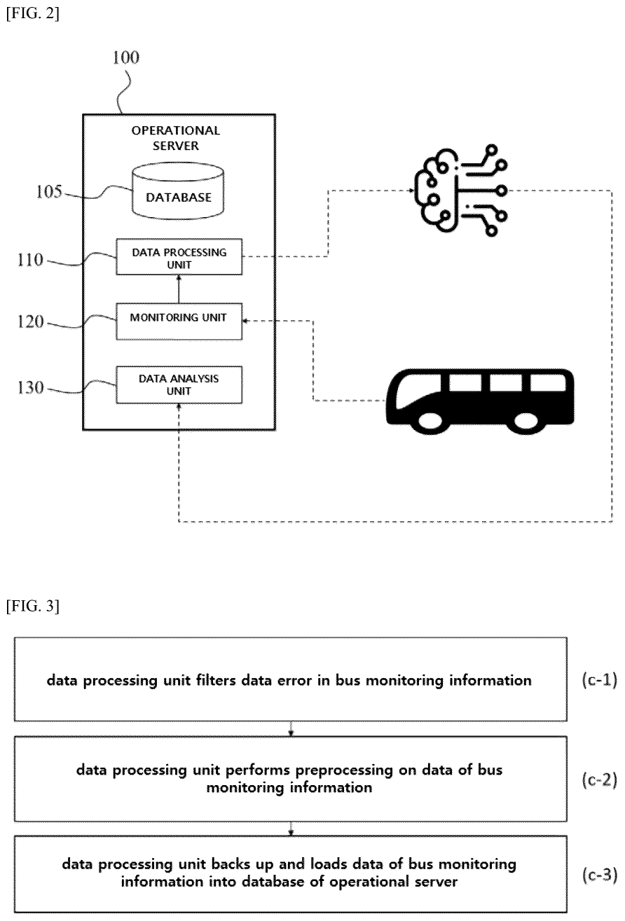

FIG. 2 is a diagram schematically illustrating each component in a system for performing the predictive maintenance algorithm providing method for bus maintenance priority determination based on real-time location information according to the embodiment of the present invention. In the following description, the symbols assigned to components are based on this drawing.

As illustrated in FIG. 1, the predictive maintenance algorithm providing method for bus maintenance priority determination based on real-time location information according to an embodiment of the present invention may include operations (a) to (f).

First, operation (a) is a process in which a data processing unit (110) of an operational server (100) groups and classifies a plurality of buses to be monitored according to preset classification criteria.

In this case, the preset classification criteria may have at least one criterion among a manufacturer, fuel, a model, year, and a system type. In addition, among these, the system type may be classified based on power, cooling/lubrication, combustion, exhaust, battery cell voltage, and battery temperature, etc.

Table 1 below shows a list of buses grouped according to the above criteria. This is presented as an example, and the grouping criteria are not limited to Table 1.

TABLE 1

| Group | Manufacturer | Fuel | Model | Year | System |
|---|---|---|---|---|---|
| 1 | H company | CNG | New Super Aero | Old type | Power Cooling/Lubrication |
| | | | City | (~2014) | Combustion |
| | | | Green city | Old type | |
| | | | | (~2014) | |
| | D company | | BS090 | No | |
| | | | | classification | |
| | | | BS106 | No | |
| | | | | classification | |
| | | | BS110 | No | |
| | | | | classification | |
| | F company | | Primus | No | |
| | | | | classification | |
| | T company | | Fibird | No | |
| | | | | classification | |
| | E company | | Smart | No | |
| | | | | classification | |
| 2 | H company | CNG | New Super Aero | New type | Power Cooling/Lubrication |
| | | | City | (2014~) | Combustion Exhaust Fuel |
| | | | Green city | New type | |
| | | | | (2014~) | |
| 3 | H company | Diesel | New Super Aero | New type | Power Cooling/Lubrication |
| | | | City | (2015~) | Combustion Exhaust Fuel |
| 4 | H company | Diesel | New county | No | Power Cooling/Lubrication |
| | | | | classification | Combustion Exhaust |
| 5 | H company | Electricity | Elec-city | 2018~2021 | Cell voltage S1 |
| | | | | | Battery temperature S1 |
| | | | | | Cell voltage S2 |
| | | | | | Battery temperature S2 |
| | | | | | Cell voltage M1 |
| | | | | | Battery temperature M1 |
| | | | | | Cell voltage M2 |
| | | | | | Battery temperature M2 |
| 6 | H company | Electricity | Elec-city | 2022~ | Cell voltage S1 |
| | | | | | Battery temperature S1 |
| | | | | | Cell voltage S2 |
| | | | | | Battery temperature S2 |
| | | | | | Cell voltage S3 |
| | | | | | Battery temperature S3 |
| | | | | | Cell voltage S4 |
| | | | | | Battery temperature S4 |
| 7 | H company | Hydrogen | Elec-city PCEV | No | Cell voltage S |
| | | | | classification | Battery temperature S |
| | | | | | Cell voltage M |
| | | | | | Battery temperature M |

Next, operation (b) is a process in which a monitoring unit (120) of the operational server (100) receives bus monitoring information including a plurality of types of data collected by vehicle information collection devices installed on buses for each group classified according to operation (a).

In this case, the vehicle information collection device may include all means installed on the bus to obtain data containing various types of mechanical/electronic information on each part of the vehicle. Since this is obvious to those skilled in the art, a detailed description thereof will be omitted.

In this way, the process in which the monitoring unit (130) receives the bus monitoring information may be performed by controller area network (CAN) communication.

Thereafter, in operation (c), the data processing unit (110) performs a process of refining the bus monitoring information.

This process may be performed to maintain the quality of a large amount of data due to the characteristics of the CAN communication method, which is collected in real time (e.g., in 1-second units).

In general, in the process of collecting the bus monitoring information, missing data and outliers may be collected depending on various situations such as communication delays (tunnel entry, etc.), vehicle failures, and terminal failures.

In the present embodiment, the bus monitoring information is used as core data for vehicle status, driving behavior analysis, and predictive maintenance models, so it is essential to establish and implement a refinement plan.

FIG. 3 is a diagram illustrating the detailed process of operation (c) in the predictive maintenance algorithm providing method for bus maintenance priority determination according to the embodiment of the present invention.

As illustrated in FIG. 3, in the present embodiment, operation (c) may specifically include operations (c-1) to (c-3).

Operation (c-1) is a process in which the data processing unit (110) filters data errors in the bus monitoring information.

This process may include data physical range checking, data redundancy processing, and abnormal data checking processes.

Operation (c-2) is a process in which the data processing unit (110) performs preprocessing on the data of the bus monitoring information.

This process may include missing value processing, outlier processing, data standardization, transformation/derived variable generation, and geocoding processes.

In addition, operation (c-3) is a process in which the data processing unit (110) backs up and loads the data of the bus monitoring information into a database (105) of the operational server.

Table 2 below describes specific methods for each process of refining the bus monitoring information.

TABLE 2

| Division | | Method |
|---|---|---|
| Error filtering | Data physical range | Filtering when a fixed limit value (maximum, minimum |
| | check | value) for a physically possible limit range is exceeded |
| | Data redundancy | Calculate an identification (ex. hash) value for a specific |
| | processing | file, block, or bit stream, and consider and process two |
| | | segments with the same identification value as duplicate |
| | | data. |
| | Abnormal data check | Remove set error data, process and filter data according to |
| | | base rule |
| Data | Missing value | Delete or replace with base-based specific value, replace |
| preprocessing | processing | with average or median value, or replace with predicted |
| | | estimate value |
| | Outlier processing | Values that appear different from the overall pattern of the |
| | | data are detected using quartile detection, residual |
| | | detection, SVDD, etc., and a processing method is similar |
| | | to missing value processing. |
| | Data standardization | Min-Max, Z-score methods, etc., are used as scaling to |
| | | match values between variables to a certain level. |
| | Transformation and | Based on logical validity, and transformation and derived |
| | derived variable | variable generation by a combination of existing variables |
| | generation | |
| | Geocoding | Extract coordinate values of latitude and longitude using |
| | | unique names (address, mountain name, etc.) |

| Backup and data loading | Backup existing original data and store data after |
|---|---|
| | refinement/analysis |

In operation (c), algorithms for identifying data to be refined, correcting missing values, determining/refining reconstruction errors, and selecting training data may be used.

Among these, the algorithm for identifying data to be refined may have a method of identifying data to be refined through basic statistical analysis and consistency checks, and making a determination in consideration of an actual operating time because a null value is a normal value when a vehicle is not operated.

In addition, a rule-based data search solution may be used to search for situations such as when there is data that is inconsistent with data consistency (for example, when numerical data contains letters) or when data is not in the form of coordinates or time.

The missing value correction algorithm is intended to predict missing values through a regression equation between observed values because there is a lot of data generated by interactions due to the nature of bus monitoring information.

Specifically, this may allow a regression equation having a variable containing the missing value as a dependent variable and the remaining variables as an independent variable to be constructed and the missing value to be replaced with a predicted value of the regression equation estimated in this way. In other words, the prediction power may be improved by constructing the regression equation according to the characteristics of the variables.

In addition, the reconstruction error determination/refinement algorithm may include a first error determination method of assuming a distribution of data to be a normal distribution and determining that the data is an outlier if it deviates from the mean by a product of a standard deviation and a sigma coefficient.

In addition, the reconstruction error determination/refinement algorithm may include a second error determination method of increasing a data retention rate by applying 3 sigma (3SD) instead of the commonly used 2 sigma (2SD) due to the high value of failure data for actual failure determination.

In addition, the reconstruction error determination/refinement algorithm may include a refinement method of replacing data determined to be erroneous with a mode derived as a result of statistical analysis.

Meanwhile, the training data selection algorithm may be performed by a method of borrowing the signal-to-noise ratio principle, considering data determined to be a reconstruction error as noise, and creating a ratio of noise to extracted data. In this case, when the calculated noise ratio accounts for more than 10% of data, it may be omitted from the training data.

Next, operation (d) is a process in which the data processing unit (110) inputs the bus monitoring information refined in operation (c) as the training data for an artificial intelligence machine to build an artificial intelligence model for determining bus maintenance priorities.

In this process, the process of training the artificial intelligence model may be performed by the following sequences: data split, train, and test.

In particular, in the present embodiment, operation (d) may be performed by repeatedly learning the same algorithm as operation (f) which is a process of deriving maintenance priority for buses to be monitored later.

This will be described again in operation (f) later, but in the present embodiment, operation (d) may be performed by a process of generating a state prediction model and a steady state model of a bus to be monitored through an artificial intelligence model and calculating a Euclidean distance between the state prediction model and the steady state model.

According to the above process, the artificial intelligence model for determining bus maintenance priority is built, and below, the process of using the constructed artificial intelligence model to derive the maintenance priority of the bus to be actually monitored is performed.

Operation (e) is a process in which the monitoring unit (120) re-receives the bus monitoring information collected by the vehicle information collection devices installed on the buses for each group classified according to operation (a).

That is, in this process, after the artificial intelligence model is built, new bus monitoring information is re-received to derive the maintenance priority for a plurality of buses that are currently being operated.

Next, in operation (f), a process in which a data analysis unit (130) of the operational server (100) derives the maintenance priority of the bus to be monitored through the artificial intelligence model based on the bus monitoring information re-received in operation (e) is performed.

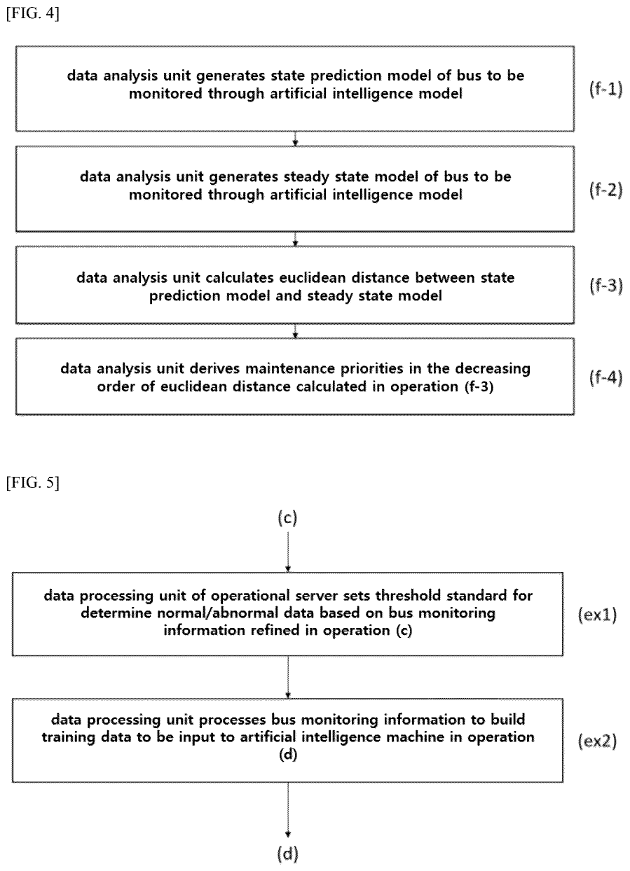

FIG. 4 is a diagram illustrating the detailed process of operation (f) in the predictive maintenance algorithm providing method for bus maintenance priority determination according to the embodiment of the present invention.

As illustrated in FIG. 4, in the present embodiment, operation (f) may specifically include operations (f-1) to (f-4).

Operation (f-1) is a process in which the data analysis unit (130) generates the state prediction model of the bus to be monitored through the artificial intelligence model, and operation (f-2) is a process in which the data analysis unit (130) generates the steady state model of the bus to be monitored through the artificial intelligence model.

These processes may be performed through the process of passing each piece of data (e.g., data on each part of a bus, environmental data such as time, temperature, rainfall, location, and humidity) of newly generated bus monitoring information for each bus through the artificial intelligence model.

In operation (f-3), a process in which the data analysis unit (130) calculates a Euclidean distance between the state prediction model and the steady state model is performed.

In addition, in operation (f-4), a process in which the data analysis unit (130) derives maintenance priorities in the decreasing order of the Euclidean distance calculated in operation (f-3) is performed.

That is, the Euclidean distance between the state prediction model and the steady state model is compared, and it is defined that the greater the distance, the greater the degree of abnormality in the state, and based on the degree of abnormality, priorities may be derived in descending order.

In addition, by reflecting these priorities, results may be classified as warning, caution, and normality according to preset criteria.

Meanwhile, the present embodiment may further include operations (ex1) and (ex2) performed between operations (c) and (d).

FIG. 5 is a diagram illustrating operations (ex1) and (ex2) performed between operations (c) and (d) in the predictive maintenance algorithm providing method for bus maintenance priority determination according to the embodiment of the present invention.

As illustrated in FIG. 5, operation (ex1) is a process in which the data processing unit (110) of the operational server (100) sets threshold standards for determining normal/abnormal data based on the bus monitoring information refined in operation (c).

Operation (ex2) is a process in which the data processing unit (110) processes the bus monitoring information to build the training data to be input to the artificial intelligence machine in operation (d).

Each of these operations may include detailed processes.

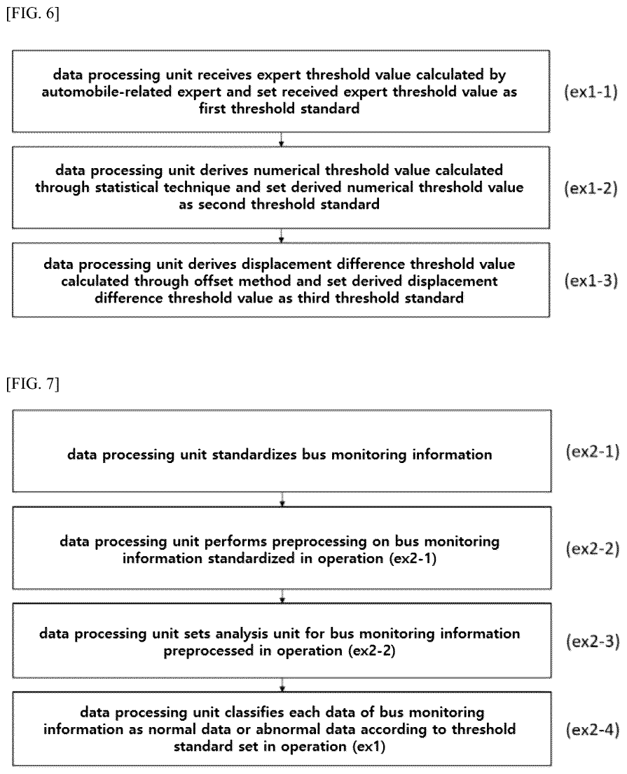

FIG. 6 is a diagram illustrating the detailed process of operation (ex1) in the predictive maintenance algorithm providing method for bus maintenance priority determination according to the embodiment of the present invention.

As illustrated in FIG. 6, in the present embodiment, operation (ex1) may include operations (ex1-1) to (ex1-3) in detail.

Operation (ex1-1) is a process in which the data processing unit (110) receives an expert threshold value calculated by an automobile-related expert and sets the received expert threshold value as a first threshold standard.

In this process, standard values for each item may be derived through external automobile-related experts (e.g., doctoral degree holders, senior level executives, engineers, master mechanics, etc.) and may be used along with the numerical threshold value determination standard to be described later.

Operation (ex1-2) is a process in which the data processing unit (110) derives a numerical threshold value calculated through statistical techniques and sets the derived numerical threshold value as a second threshold standard.

In this process, Six Sigma, which is a statistical method, may be used to set rule base standards for each sensor required for abnormality detection analysis. Six Sigma represents the standard deviation from a normal distribution and quantifies the ability of a process to produce the number of good products (normal) within 6 standard deviations.

In the case of the present embodiment, based on the data for each sensor, data exceeding the limit of ±6 standard deviations was determined to be outliers.

In addition, operation (ex1-3) is a process in which the data processing unit (110) derives a displacement difference threshold value calculated through an offset method and sets the derived displacement difference threshold value as a third threshold standard.

In this way, in operation (d) through operation (ex1), the training data to be input to the artificial intelligence machine may be built.

Table 3 below lists equipment data of the bus built with the training data through operation (ex1), and Table 4 lists environmental data of the bus built with the training data through operation (ex1).

TABLE 3

| Column name | Description |
|---|---|
| Date | Date (2002 May 2T04: 55:23.084) |
| SystemTime | System time (data logger uptime) |
| Abstime | Time (data logger absolute time) |
| ECU_BatteryVolt(V) | Battery voltage (V) |
| ECU_LambdaTarget | Air-fuel ratio target value |
| ECU_Lambda_B1S1 | Oxygen sensor value |
| ECU_FuelTankChargingRate(%) | Fuel tank charging rate (%) |
| ECU_PressureBeforeThrottle(kPa) | Pressure before throttle (kPa) |
| ECU_IntakeAirTemp(° C.) | Intake temperature (° C.) |
| ECU_IntakeAirPressure(kPa) | Intake pressure (kPa) |
| ECU_AtmosphericPressure(kPa) | Atmospheric pressure(kPa) |
| ECU_VehicleSpeed_STD(km/h) | Vehicle speed (km/h) |
| ECU_BrakeSW | Brake |
| ECU_ClutchSW | Clutch |
| ECU_AccelPedal(%) | Accelerator pedal position sensor (%) |
| ECU_BoostControl(%) | Acceleration control(%) |
| ECU_BoostPressure(kPa) | Acceleration pressure (kPa) |
| ECU_InjectionGasTepmp(° C.) | Gas injection temperature (° C.) |
| ECU_EngineTorqueActual(%) | Actual engine torque value (%) |
| ECU_Engine TorqueTarget(%) | Target engine torque value (%) |
| ECU_EngineSpeed(rpm) | Engine speed (RPM) |
| ECU_CoolantTemp(° C.) | Coolant temperature (° C.) |
| GPSTime | GPS time |
| Latitude | Latitude |
| Longitude | Longitude |
| d | Date (2022 May 2) |

TABLE 4

| Column name | Description |
|---|---|
| Date | Date |
| Latitude | Latitude |
| Longitude | Longitude |
| ECU_BatteryVolt(V) | Battery voltage (V) |
| ECU_CoolantTemp(° C.) | Coolant temperature (° C.) |
| ECU_InjectionGasTemp(° C.) | Gas injection temperature (° C.) |
| ECU_EngineTorqueActual(%) | Engine percentage torque (%) |
| ECU_EngineTorqueRequest(%) | Requested torque (%) |
| Temperature(° C.) | Temperature (° C.) |
| Humidity(%) | Humidity (%) |
| Precipitation (mm) | Precipitation (mm) |
| ECU_VehicleSpeed_STD(km/h) | Vehicle speed (km/h) |
| ECU_EngineSpeed(rpm) | Engine speed (rpm) |

FIG. 7 is a diagram illustrating the detailed process of operation (ex2) in the predictive maintenance algorithm providing method for bus maintenance priority determination according to the embodiment of the present invention.

As illustrated in FIG. 7, in the present embodiment, operation (ex2) may specifically include operations (ex2-1) to (ex2-4).

Operation (ex2-1) is a process in which the data processing unit (110) standardizes the bus monitoring information.

This process is intended to standardize common parts in order to minimize a preprocessing work on data for each vehicle type and fuel system, and the standardization targets may include date, time, location, file configuration, etc.

Operation (ex2-2) is a process in which the data processing unit (110) performs preprocessing on the bus monitoring information standardized by operation (ex2-1).

In this process, data that may indicate each state, such as power, coolant, and combustion, is selected, and then, normal data may be extracted according to the threshold value for each piece of data.

In addition, this process may go through a training data construction process of determining whether the outliers are included in each data interval according to the threshold standard set in operation (ex1) described above, and then, increasing a data formation rate including outliers while widening a data interval when the proportion of data including outliers is too low.

In this case, when the data value is too large or too small, there is a possibility that it may converge to 0 or diverge to infinity in the artificial intelligence model training process, so it may go through a data scaling process such as StandardScaler or Min-Max Scaler.

Next, operation (ex2-3) is a process in which the data processing unit (110) sets an analysis unit for the bus monitoring information preprocessed in operation (ex2-2).

This process is for adding a condition column to all the training data to add normal data by considering driver characteristics as well as climate and road conditions.

For example, this process may adjust an input data length for data composed of condition columns such as weather, engine and vehicle speed, and latitude/longitude, and monitoring columns such as voltage and temperature, to derive the artificial intelligence model that produces optimal performance.

Operation (ex2-4) is a process in which the data processing unit (110) classifies each piece of data of the bus monitoring information as normal data or abnormal data according to the threshold standard set in operation (ex1) described above.

In this process, the normal data is extracted by calculating the number of times each piece of data in the bus monitoring information deviates from the threshold standard or the bus operation time.

Through these operations (ex1) and (ex2), the training data to be input to the artificial intelligence machine in step (d) may be built.

As described above, the present invention may group a plurality of buses to be monitored according to the preset classification criteria and collect bus monitoring information in real time and use the collected bus monitoring information as the training data to derive the artificial intelligence model for determining bus maintenance priorities, thereby deriving bus maintenance priorities according to reasonable and objective standards.

In particular, the present invention can be applied to electric buses and hydrogen electric buses that are not currently subject to regular inspection, thereby preventing accidents and breakdowns even in eco-friendly vehicles.

In order to solve the above problems, a predictive maintenance algorithm providing method for bus maintenance priority determination of the present invention can group a plurality of buses to be monitored according to preset classification criteria and collect bus monitoring information in real time and use the collected bus monitoring information as training data to derive an artificial intelligence model for determining bus maintenance priorities, thereby deriving bus maintenance priority based on reasonable and objective standards.

In particular, the present invention can be applied to electric buses and hydrogen electric buses that are not currently subject to regular inspection, thereby preventing accidents and breakdowns even in eco-friendly vehicles.

The effects of the present invention are not limited to the above-described effects. That is, other effects that are not described may be obviously understood by those skilled in the art from the claims.

As described above, the exemplary embodiments according to the present invention have been examined, and the fact that the present invention can be embodied in other specific forms without departing from the spirit or scope thereof in addition to the above-described embodiments is obvious to those skilled in the art. Therefore, the embodiments described above are to be regarded as illustrative rather than restrictive, and thus the present invention is not limited to the above description, but may be modified within the scope of the appended claims and their equivalents.

### Description of the Symbols

100: OPERATIONAL SERVER
105: DATABASE
110: DATA PROCESSING UNIT
120: MONITORING UNIT
130: DATA ANALYSIS UNIT

1. A predictive maintenance algorithm for providing a method for bus maintenance priority determination, comprising operations of:
(a) grouping and classifying, by a data processing unit of an operational server, a plurality of buses to be monitored according to a preset classification criterion;
(b) receiving, by a monitoring unit of the operational server, bus monitoring information including a plurality of types of data collected by vehicle information collection devices installed on the buses for each group classified according to the operation (a);
(c) performing, by the data processing unit, refinement on the bus monitoring information;
(d) inputting, by the data processing unit, the bus monitoring information refined in the operation (c) as training data for an artificial intelligence machine to build an artificial intelligence model for determining bus maintenance priorities;
(e) re-receiving, by the monitoring unit, the bus monitoring information collected by the vehicle information collection devices installed on the buses for each group classified according to the operation (a); and
(f) deriving, by a data analysis unit of the operational server, the maintenance priority of the bus to be monitored through the artificial intelligence model based on the bus monitoring information re-received in the operation (e).

2. The predictive maintenance algorithm providing method of claim 1, wherein the preset classification criterion in the operation (a) has at least one criterion selected from the group consisting of a manufacturer, fuel, a model, year, and a system type.

3. The predictive maintenance algorithm providing method of claim 1, wherein the operation (c) comprises:
(c-1) filtering, by the data processing unit, a data error in the bus monitoring information;
(c-2) performing, by the data processing unit, preprocessing on data of the bus monitoring information; and
(c-3) backing up and loading, by the data processing unit, the data of the bus monitoring information into a database of the operational server.

4. The predictive maintenance algorithm providing method of claim 1, wherein the operation (f) comprises:
(f-1) generating, by the data analysis unit, a state prediction model of the bus to be monitored through the artificial intelligence model;
(f-2) generating, by the data analysis unit, a steady state model of the bus to be monitored through the artificial intelligence model;
(f-3) calculating, by the data analysis unit, a Euclidean distance between the state prediction model and the steady state model; and
(f-4) deriving, by the data analysis unit, maintenance priorities in the decreasing order of the Euclidean distance calculated in the operation (f-3).

5. The predictive maintenance algorithm providing method of claim 1, further comprising, between the operations (c) and (d), operation (ex1) of setting, by the data processing unit of the operational server, a threshold standard for determining normal/abnormal data based on the bus monitoring information refined in the operation (c).

6. The predictive maintenance algorithm providing method of claim 5, wherein the operation (ex1) comprises one or more operations selected from the group consisting of:
(ex1-1) receiving, by the data processing unit, an expert threshold value calculated by an automobile-related expert and setting the received expert threshold value as a first threshold standard;
(ex1-2) deriving, by the data processing unit, a numerical threshold value calculated through a statistical technique and setting the derived numerical threshold value as a second threshold standard; and
(ex1-3) deriving, by the data processing unit, a displacement difference threshold value calculated through an offset method and setting the derived displacement difference threshold value as a third threshold standard.

7. The predictive maintenance algorithm providing method of claim 5, further comprising, after the operation (ex1), operation (ex2) of processing, by the data processing unit, the bus monitoring information to build the training data to be input to the artificial intelligence machine in the operation (d).

8. The predictive maintenance algorithm providing method of claim 7, wherein the operation (ex2) comprises operations of:
(ex2-1) standardizing, by the data processing unit, the bus monitoring information;
(ex2-2) performing, by the data processing unit, preprocessing on the bus monitoring information standardized in the operation (ex2-1);
(ex2-3) setting, by the data processing unit, an analysis unit for the bus monitoring information preprocessed in the operation (ex2-2); and
(ex2-4) classifying, by the data processing unit, each piece of data of the bus monitoring information as normal data or abnormal data according to the threshold standard set in the operation (ex1).
